(19) United States
(12) Patent Application Publication
(10) Pub. No.: US 2025/0278772 A1
(43) Pub. Date: Sep. 4, 2025

(54) ONLINE AND ADAPTIVE CROSS-DOMAIN RECOMMENDER SYSTEM

(71) Applicant: Samsung Electronics Co., Ltd., Suwon-si (KR)

(72) Inventors: Muchlisin Adi SAPUTRA, Jakarta (ID); Dakhilullah Muhazzib DARWISY, Jakarta (ID); Harits ABDURROHMAN, Jakarta (ID); Aisyah AWALINA, Jakarta (ID); Arief SAFERMAN, Jakarta (ID); Wava Carissa PUTRI, Jakarta (ID)

(21) Appl. No.: 18/781,203

(22) Filed: Jul. 23, 2024

Related U.S. Application Data
(63) Continuation of application No. PCT/KR2024/010097, filed on Jul. 15, 2024.

(30) Foreign Application Priority Data
Mar. 1, 2024 (ID) P00202401928

(51) Int. Cl. G06Q 30/0601; G06Q 30/0203; G06Q 30/0217; G06Q 30/0282

(52) U.S. Cl. CPC G06Q 30/0631; G06Q 30/0203; G06Q 30/0217; G06Q 30/0282

(57) ABSTRACT

A method, performed by an electronic device, for a Recommender System that can adapt to various domains is provided. The method may include providing, by the electronic device, a recommendation to a user based on a profile of the user, receiving, by the electronic device, feedback based on the recommendation, and providing, by the electronic device, an updated recommendation based on the received feedback, wherein the feedback is at least one of explicit or implicit.

### CROSS-REFERENCE TO RELATED APPLICATION(S)

This application is a continuation application, claiming priority under § 365 (c), of an International application No. PCT/KR2024/010097, filed on Jul. 15, 2024, which is based on and claims the benefit of an Indonesian patent application number P00202401928, filed on Mar. 1, 2024, in the Indonesian Intellectual Property Office, the disclosure of which is incorporated by reference herein in its entirety.

### TECHNICAL FIELD

The disclosure relates to a method of filtering information and creating a recommendation system based on user preferences. More particularly, the disclosure relates to a cross-domain recommendation system using a reinforcement-learning (RL) method in an offline and online training manner.

### BACKGROUND OF THE INVENTION

In recent years, Recommender Systems have been widely used on a system to gain interaction with customers. As the name suggests, the Recommender System provides selected items based on how relevant those items are to the history of user activities, e.g. user-item interactions. In some cases, similar item recommendations might occur to users with similar activities. A good recommendation is determined by how the suggested item piques the interest of the user. Certain feedback such as ratings from users could help the system in evaluating suggestions and enhance recommendations. On the other hand, insufficient information could cause data sparsity problems. The causality comes when missing data or the associated service does not provide further information. Data sparsity mostly occurs on rating feedback, considering not all users gave responses to the items bought.

Recommender Systems strategically present items from their catalog to customers, fostering increased engagement and traffic. These days, a single Recommender System can provide massive information across multiple services, catering to millions of users while upholding quality standards for each service. Therefore, a cross-domain recommender model is required to accommodate serving multiple services, particularly on the service with insufficient user-item interaction which causes cold-start problems and data sparsity.

The cross-domain recommender model functions as a knowledge assistant to a service, leveraging insights gained from other services to aid in the adaptation of a new service to an Recommender System. This unique feature is absent in single-domain recommender models, where a new service may lack substantial information about users and items, constituting what is commonly known as the cold-start problem. Sufficient data is indispensable to maintain the quality of recommendations.

In response to evolving customer preferences, the adoption of online learning becomes imperative. This methodology in Artificial Intelligence involves periodic re-training of an machine learning models or triggered updates, such as alerts indicating a shift in production trends or a decline in model accuracy and precision. Online learning ensures model updates when new data or observations become available.

Apart from the aforementioned challenges, larger Recommender Systems encounter some issues, e.g., aligning different data types during training sessions. Heterogeneity is prevalent in systems with numerous services, where feedback from users may vary in format, such as textual reviews and numerical ratings. Achieving optimal alignment across services necessitates a robust system. Furthermore, potential data drift at the production level can undermine recommendation precision due to shifts in data distribution, and online learning emerges as a viable solution.

To the best of the Inventor's knowledge, there are several related arts exploring Recommender Systems in multi-domain. However, none of the related arts discussed a method of online adaptive training which is a tuning model with user feedback in real-time.

First related art proposed a comprehensive system for Multi-domain Recommendation with a focus on item level, designed to furnish a list of items with similar attributes. In contrast, the disclosure employs “Cross-Domain Recommendation” to elevate the Multi-domain concept by addressing scenarios where the target domain possesses limited user information

Second related art, social network content recommendation system, enables users to identify friends, recommend content, and receive awards for influencing friends.

Third related art provides a system leveraging metadata to enhance content classification. This content recommendation processing system automatically annotates and classifies content items using multiple metadata tags describing content attributes. In contrast to the second and third related arts, the disclosure does not utilize metadata or users' social activities. Instead, it relies on user history and rating feedback to construct the user profile.

Fourth related art utilizes feedback as weighting to enhance recommendations based on predictive models. It incorporates user viewing history, emphasizing that one viewing history may not sufficiently align with others. By weighting user preferences and viewing historical information based on criteria such as feedback from previous recommendations, this media system enhances the accuracy of content recommendations. In contrast, the disclosure incorporates both implicit and explicit feedback. Additionally, most cross-domain Recommender Systems generate a general representation for each domain to address insufficient matches.

The above information is presented as background information only to assist with an understanding of the disclosure. No determination has been made, and no assertion is made, as to whether any of the above might be applicable as prior art with regard to the disclosure.

### SUMMARY OF THE INVENTION

Aspects of the disclosure are to address at least the above-mentioned problems and/or disadvantages and to provide at least the advantages described below.

No architecture model is generic enough to adapt to certain conditions, which frequently occur in the online environment. The absence of this adaptability could become a technical debt in the future, particularly when many services are integrated with various data formats and fast-changing user data. In addressing these challenges, the disclosure may identify some solutions such as cross-domain integration for new services, online learning to navigate trend shifts, and alignment of different data formats.

The above-identified technologies demonstrate various approaches to recommendation systems, with distinctions in terms of domain specificity, metadata utilization, social network integration, and feedback weighting. The disclosure may introduce a cross-domain recommendation model, which has the ability to integrate with limited to no user information in the target domain and emphasize the utilization of implicit and explicit feedback for enhanced user profiling.

Additional aspects will be set forth in part in the description which follows and, in part, will be apparent from the description, or may be learned by practice of an embodiment.

In accordance with an aspect of the disclosure, a method performed by an electronic device, is provided. The method may include providing, by the electronic device, a recommendation to a user based on a profile of the user. The method may include receiving, by the electronic device, feedback based on the recommendation. The method may include providing, by the electronic device, an updated recommendation based on the received feedback. The method, wherein the feedback is at least one of explicit or implicit.

In accordance with another aspect of the disclosure, an electronic device is provided. The electronic device may include a display. The electronic device may include memory storing one or more computer programs. The electronic device may include one or more processors communicatively coupled to the display and the memory. The one or more computer programs include computer-executable instructions that, when executed by the one or more processors, may cause the electronic device to provide a recommendation to a user based on a profile of the user. The one or more processors may cause the electronic device to receive feedback based on the recommendation. The one or more processors may cause the electronic device to provide an updated recommendation based on the received feedback, wherein the feedback is at least one of explicit or implicit.

In accordance with another aspect of the disclosure, one or more non-transitory computer-readable storage media storing one or more computer programs including computer-executable instructions that, when executed by one or more processors of an electronic device, cause the electronic device to perform operations are provided. The operations may include providing, by the electronic device, a recommendation to a user based on a profile of the user. The operations may include receiving, by the electronic device, feedback based on the recommendation. The operations may include providing, by the electronic device, an updated recommendation based on the received feedback, wherein the feedback is at least one of explicit or implicit.

In accordance with an aspect of the disclosure, a computer-readable storage medium storing instructions is provided. The instructions, when executed by at least one processor, may cause the at least one processor to perform the method corresponding.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWING

The above and other aspects, features, and advantages of certain embodiments of the disclosure will be more apparent from the following description taken in conjunction with the accompanying drawings, in which:

FIG. 1 is the diagram overview of data flow in the Online Adaptive Cross-domain Recommender System according to an embodiment of the disclosure;

FIG. 2 is a general overview system of the Online Adaptive Cross-domain Recommender System according to an embodiment of the disclosure;

FIG. 3 is an illustration of the integration new service with the Online Adaptive Cross-domain Recommender System according to an embodiment of the disclosure;

FIG. 4 is an illustration of Feedback Adjustment on the Cross-domain Recommender model according to an embodiment of the disclosure;

FIG. 5 is an illustration of Adaptive data drift with the Online Adaptive Cross-domain Recommender System according to an embodiment of the disclosure;

FIG. 6 is an illustration of the Cross-domain Recommender System on the local Samsung Application according to an embodiment of the disclosure;

FIG. 7 is an illustration of Offline Training according to an embodiment of the disclosure;

FIG. 8 is an overview of Online and Adaptive Training according to an embodiment of the disclosure;

FIG. 9 is the flow process in the Online Adaptive Cross-domain Recommender System according to an embodiment of the disclosure;

FIG. 10 is an Agent Trainer Part of the overall online adaptive method according to an embodiment of the disclosure;

FIG. 11 is a Feedback Processing in an overall Online Adaptive Cross-domain Recommender System according to an embodiment of the disclosure;

FIG. 12 is an overview of Generic Feedback-Reward Processing in an Overall Online Adaptive Cross-domain Recommender System according to an embodiment of the disclosure;

FIG. 13 is a data flow of Reward Labeling & Auto Labeling according to an embodiment of the disclosure;

FIG. 14 is an Online Adaptive Cross-domain Recommender System Labelling Tools Wireframe according to an embodiment of the disclosure; and

FIG. 15 is the calculation of Generic Feedback-Reward according to an embodiment of the disclosure.

Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B”, “at least one of A and/or B”, or “one or more of A and/or B” may include all possible combinations of A and B. For example, “A or B”, “at least one of A and B”, and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

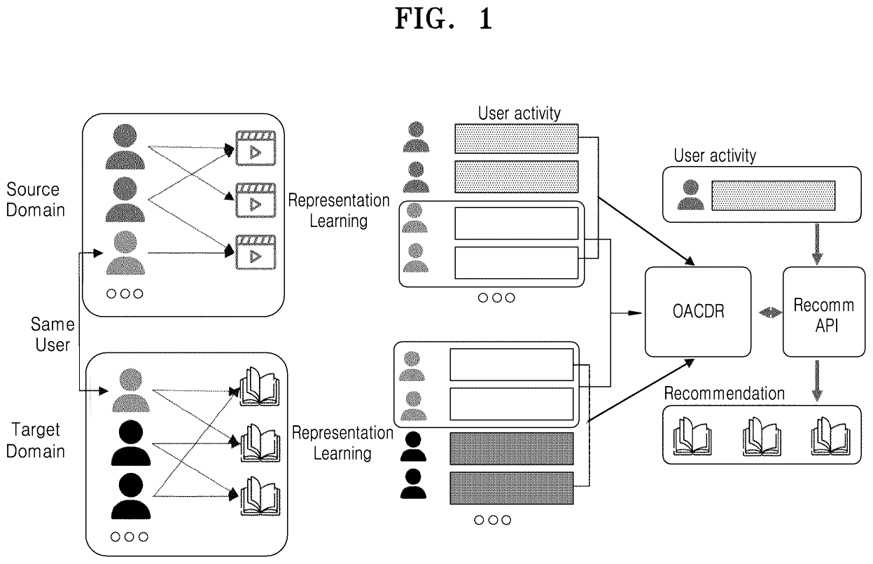

Preferred embodiments and their advantages are best understood by referring to FIGS. 1 through 15. Accordingly, it is to be understood that the embodiments of the disclosure herein described are merely illustrative of the application of the principles of the disclosure. Reference herein to details of the illustrated embodiments is not intended to limit the scope of the claims, which themselves recite those features regarded as essential to the disclosure.

FIG. 1 is the diagram overview of data flow in the Online Adaptive Cross-domain Recommender System according to an embodiment of the disclosure.

Referring to FIG. 1, an overview of data flow in the Online Adaptive Cross-Domain Recommender System. In the common cross-domain recommendation system, there are two kinds of domains, which describe the different characteristics or item recommendations. The Source Domain is the domain that may act as the source of information to transfer to target domains and commonly have more information or user interaction. The Target Domain may act as the target of the information transfer from other domains and be commonly known for less information or user interaction. The cross-domain recommendation objective is to try to learn the relationship between both domains and can give the recommendation cross between domains even though the user does not have any information in the domain, e.g., the target domain, which has less information.

Referring to FIG. 1, the system will consume and learn user activity information and process the information into a recommendation for source domain and target domain. This disclosure proposes an Online and Adaptive Cross-Domain Recommendation System or OACDR System. The system has advantages easy to set up on any static Cross-domain Recommendation model and adapts to the dynamic of user behavior or interest. It has the ability to update the model in the online fashion, aiming to catch user behavior drift.

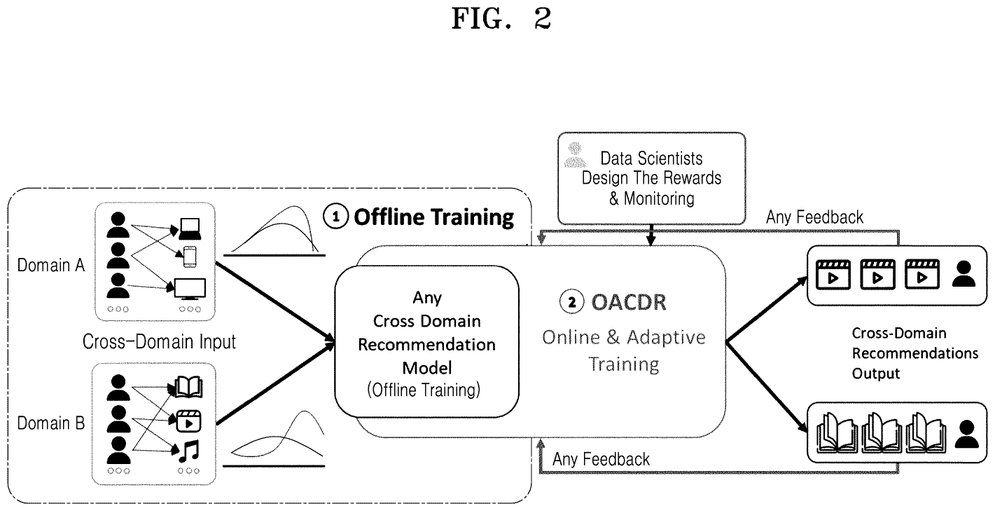

FIG. 2 is a general overview system of the Online Adaptive Cross-domain Recommender System according to an embodiment of the disclosure.

Referring to FIG. 2, it explains the general overview of the system consists of two modules, Offline Training and Online & Adaptive Training. The first module, Offline Training, may have the objective to train the base cross-domain model by learning knowledge from multiple domains. In Offline Training, we are able to employ any cross-domain recommendation model, as the system will improve it in the second module. The second module, Online & Adaptive Training may be the main core tech of this disclosure. It may optimize the basic cross-domain recommendation to adapt to the dynamic of user behavior or interest. In this disclosure, we are able to utilize any feedback from users regardless of the basic cross-domain recommendation input model to improve the performance.

Components in Online & Adaptive Training may have the ability to combine a new approach to integrate both explicit and implicit feedback of the recommendation system in an offline and online training manner. In this disclosure, the term “online” comes from the method training of using Reinforcement Learning (RL) as a means to further fine-tune the pre-trained model. In the disclosure, we used the term “offline training” for any cross-domain recommendation model applied in the previous section. Additionally, the term “adaptive” comes from the ability of the trained model to adapt to a change of concept or concept drift of user behavior, while simultaneously making the model more personalized to the user.

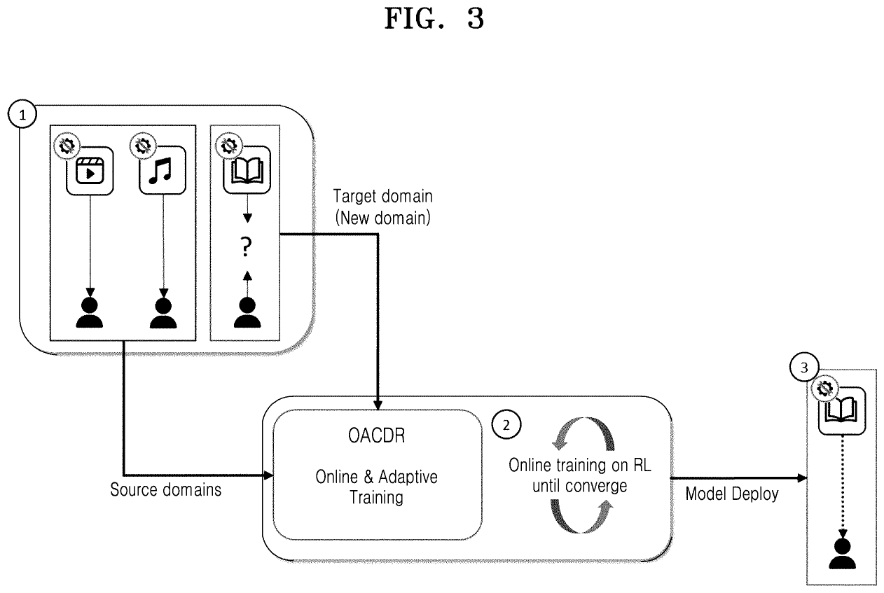

FIG. 3 is an illustration of the integration new service with the Online Adaptive Cross-domain Recommender System according to an embodiment of the disclosure.

Referring to FIG. 3, it shows the use case illustration for the integration new service with OACDR. Operation 1 is choosing the source domain to transfer its knowledge. In this operation, data scientist may determine which knowledge from available services can be transferred to the target domain during Online Training. The main idea of knowledge transfer is to create a similar behavior and/or user profile that is expected to be the new service user's profile. Operation 2 is to re-train the system until it converges. After choosing the source domain, the system will re-train its model to the new domain until it converges. In this operation, Data Scientists may be able to maintain the performance of the model in advance of achieving satisfaction or desired evaluation results. Operation 3 is to deploy on production means to deploy the model on the online environment.

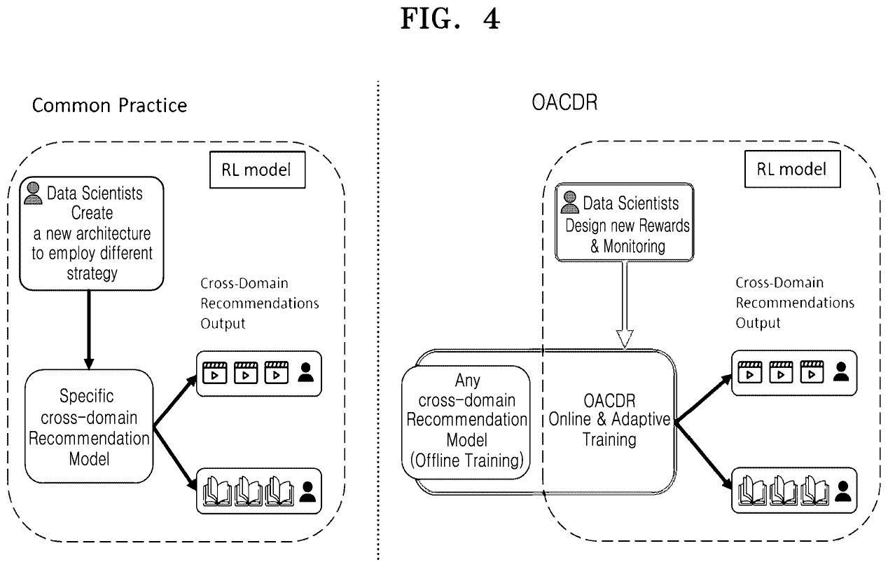

FIG. 4 is an illustration of Feedback Adjustment on the Cross-domain Recommender model according to an embodiment of the disclosure.

Referring to FIG. 4, it describes the use case illustration on Feedback Adjustment for the CDR model when the current recommendation strategy needs to change to accommodate business value. Data Scientists can design a reward function that reflects its business values using Reinforcement Learning. The use of Reinforcement Learning in the Recommender System helps the Data Scientist design its reward function to reflect its business values. There are several examples of design reward functions that can maximize business values or correspond to business process. The first example is a reward with a rating function to provide the item's feedback.

The second example is RFM-based reward which stands for Retention, Frequency, and Monetary. Retention shows item suggestions from the user's recurrent buys for a specific item. In this type of reward, the system could suggest cross-selling products by showing similar things with the current item on user preference. Frequency modifies the reward function to act on the number of sold items that increased over a period for a certain user profile. Monetary prioritize product which has the possibility to add revenue stream for certain users.

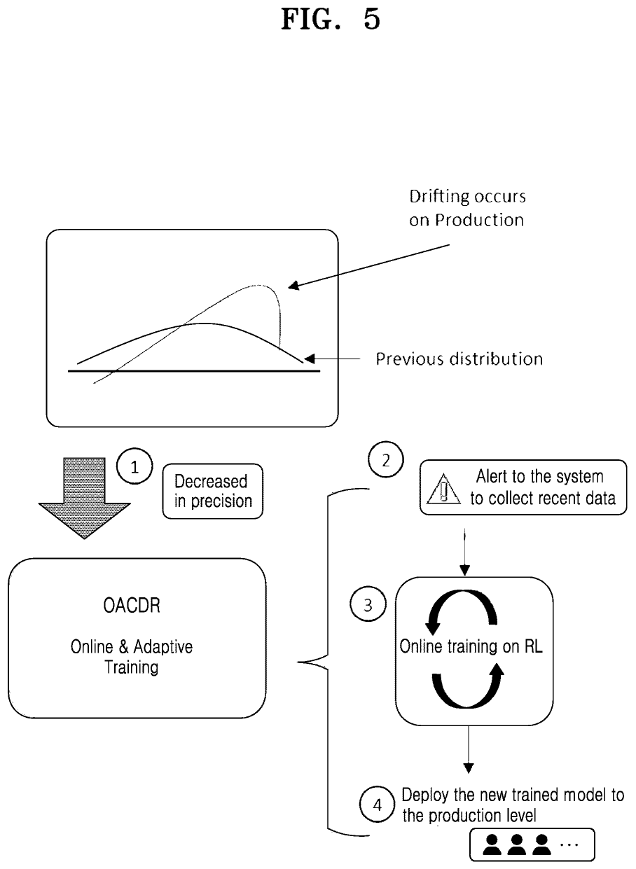

FIG. 5 is an illustration of Adaptive data drift with the Online Adaptive Cross-domain Recommender System according to an embodiment of the disclosure.

Referring to FIG. 5, it describes the use case illustration on Adaptive data drift with OACDR. In this disclosure, the system may implement reinforcement learning to maintain precision during the shifting of trends in the data. There are several advantages of maintaining precision during the shifting of trends in the data elaboration. First, data drifting occurs due to customers' shift in their interest in particular products with a range of a short time to a monthly shifting interest. Second, drifting causes a decrease in the model's precision, leading to undesired results for the users. Third, OACDR will retrain the model using reinforcement learning in order to fit with the current trends, which are explained by operations. Operation 1, data drifting occurs on the production level, lowering the precision. Operation 2, the system is triggered and reacts to collect the recent data. Operation 3, OACDR will retrain the recent data. Operation 4 is the transformation of the model seamlessly into production with the newly trained model.

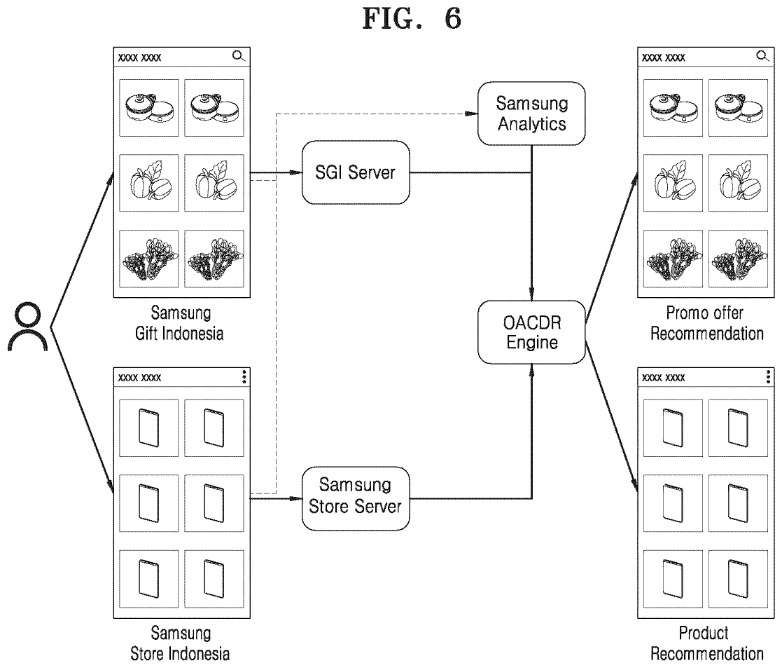

FIG. 6 is an illustration of the Cross-domain Recommender System on the local Samsung Application according to an embodiment of the disclosure.

Referring to FIG. 6, it describes the real use case illustration of a cross-domain recommender system on a local Samsung App (SGI). Samsung Indonesia has developed an application to provide Samsung device users with promo offers from various merchants, called Samsung Gift Indonesia (SGI). In the SGI App, there is a page that promotes the Samsung device from Samsung Store Indonesia. However, there are two apps with two different content, different feedback systems, and different Recommender System. This disclosure tries to enhance the store page with our recommendation.

This disclosure aims to tackle some challenges in the current recommendation system. The first is to offer personalized recommendations to the user in each of the services. The second is to increase Samsung Store Indonesia Traffic. The third is to deliver the Samsung product device to the correct target user through a recommendation system. As a solution, OACDR may cover two domains, Samsung Gift Indonesia and Samsung Store Indonesia with different systems of recommendation and feedback underlying both apps.

In Samsung Gift Indonesia, SGI server may use feedback from the interaction of users with a promo to generate recommendations. The first is View, which describes the user view of the promo. The second is Redeem, which describes users picking and registering for the promo. The third is Claims, which describes user action in claiming the promo to the merchant. The fourth is Rating, which describes users rating the promo. The categories of promo that users can pick are Buy 1 Get 1, Cashback, Discount, Free Others, Samsung, and Vouchers.

In Samsung Store Indonesia, Samsung Store Server may use the interaction of users with the devices used to generate recommendations. The first is View, which describes how users view the device. The second is Click, which describes users clicking the device page. The Third is Buy, which describes the user's actual purchase of the device.

In the long run, the application of our recommender system in both domains, Samsung Gift Indonesia (SGI) and Samsung Store Indonesia may bring indirect benefits to increase sales of Samsung Store Indonesia through the SGI Page and vice versa, increase user retention with the personalized recommendation, introduce a wider range of product variations to the user.

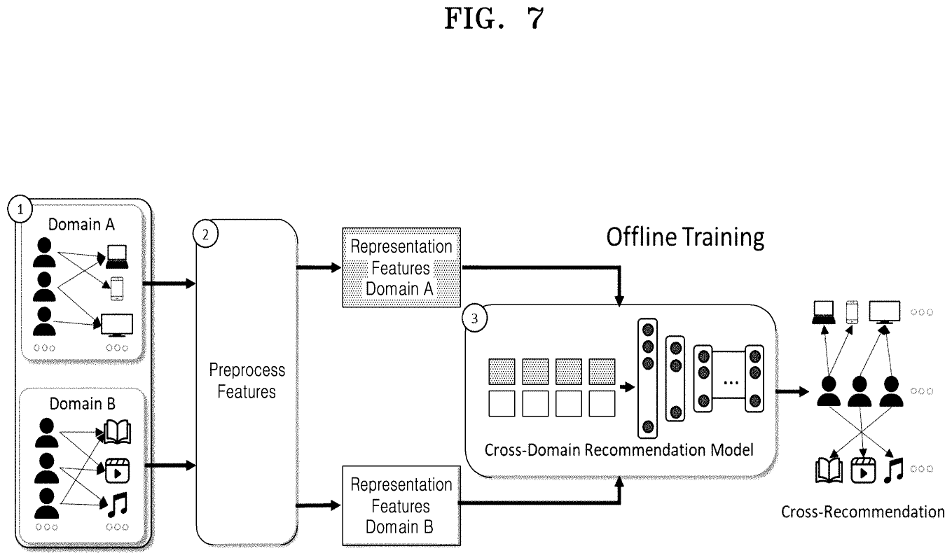

FIG. 7 is an illustration of Offline Training according to an embodiment of the disclosure.

Referring to FIG. 7, it describes the part of the system, Offline Training.

Offline Training aims to train recommendation models from multiple domains using pre-collected data. This disclosure focuses on the usage of any Machine Learning neural network-based model as long as the structure can train in a cross-domain method. There are several operations in Offline Training in common by generating cross-recommendation starting. Operation 1 is Data Gathering. In this operation, the system may process implicit feedback e.g. user purchase/click history and user behavior, or explicit feedback e.g. ratings and reviews using a machine learning model. Operation 2 is Preprocess Features. In this operation, the system may process input data to a form that a computer can understand. This often means creating numerical representations of users and items, like user and item vectors. Operation 3 is the Cross-Domain Recommendation Model. the system may proceed to data to the model to learn and build a recommendation model based on all domains' knowledge and apply the knowledge for each domain to generate recommendations, e.g. source to target and vice versa.

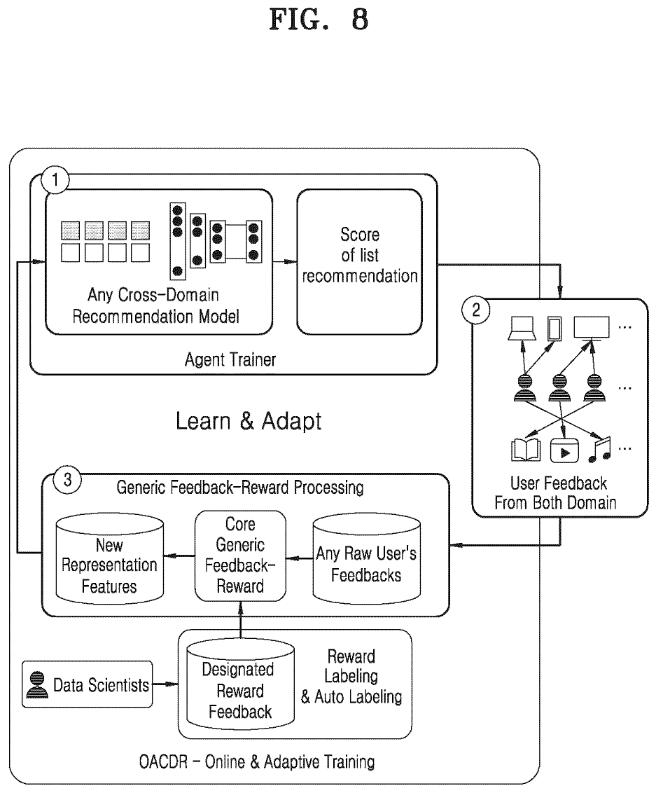

FIG. 8 is an overview of Online and Adaptive Training according to an embodiment of the disclosure.

Referring to FIG. 8, it describes the components of Online & Adaptive Training which may consist of three (3) parts. First is Agent Trainer, a component responsible for giving a reasonable recommendation based on user profiles that correspond to the target domain. Agent Trainer also acts as RL agent. Generally, this is the initial point of the system and later, when it comes to the evaluation of Online Training, this part will be retrained. Second is User Feedback, a component for recommendation since it requires reflecting the user behavior to give a better suggestion. User feedback can be any form, e.g. user review (text) or ratings (numerical). Third is Generic Feedback-Rewarding Processing. This component will process the user feedback to create a valuable evaluation for the Agent Trainer. Data Scientists also work on and maintain this part because it has to mimic the business value that directly correlates with the Recommender System.

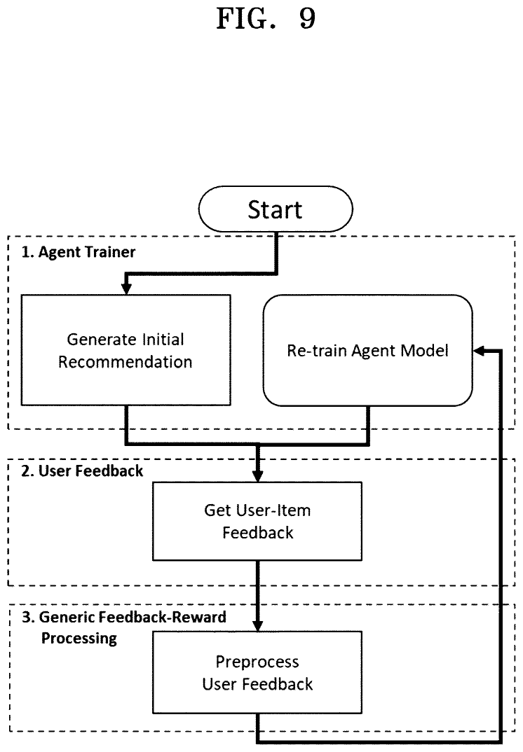

FIG. 9 is the flow process in the Online Adaptive Cross-domain Recommender System according to an embodiment of the disclosure.

Referring to FIG. 9, it shows the flow process of our Online Adaptive Cross-domain Recommender (OACDR) System. First is Agent Trainer, the part that may focus on nurturing any cross-domain recommender model to the system as an RL agent. The initialization process may start with the Agent Trainer generating a recommendation list based on the offline training process on the selected cross-domain Recommender System model. In this part, there are two processes involved which are initial recommendation generation and re-train of agent models.

The first process is Initial Recommendation Generation. Unlike in offline training, where the system can utilize any cross-domain training method, the Agent Trainer in the disclosure may be retrained again based on collected data on Online & Adaptive Training with the Reinforcement Learning method. The system may use a record of user activity to build a user behavior. The user behavior (explicit or implicit) may turn into latent knowledge known as implicit representation across domains to generate Cross-domain recommendations.

The second process is the retraining of Agent Models. In this online training part, the recommendation list, generated from implicit representation, may serve as an action with the whole item directory acting as a state. The system may use the processed numerical representation as a reward to shift the recommender agent bias toward the latest preferences. The retrained Agent Models may generate an updated recommendation reflecting the user's latest preferences. The system may provide the updated recommendation to the user.

In general, RL usually takes action based on the state of the environment and gets the reward. By using this reward, RL will evaluate its agent to return a better action to correspond to the state.

In the Recommender System, the recommendation model may return the NDCG@k score. This score may indicate how closely the suggested item is with the user preferences. NDCG may return many values, therefore the system only took the top-k result by ranking.

$$NDCG @ k = {N}_{k}^{- 1} {\sum }_{j = 1}^{k} g ( {r}_{j} ) d ( j ) \qquad Equation 1$$

Where g(*) is the rank function and d(j) is the score function. k is the number of top-rank recommendations.

The disclosure designed a modified reward mechanism, which can be denoted as this equation:

$$Global Reward = NDCG @ k \times Generic Reward \qquad Equation 2$$

The reward is added from the Generic Reward and NDCG@k score. Generic reward is a feature in the disclosure which tailored by the Data Scientist in order for RL to express the business process.

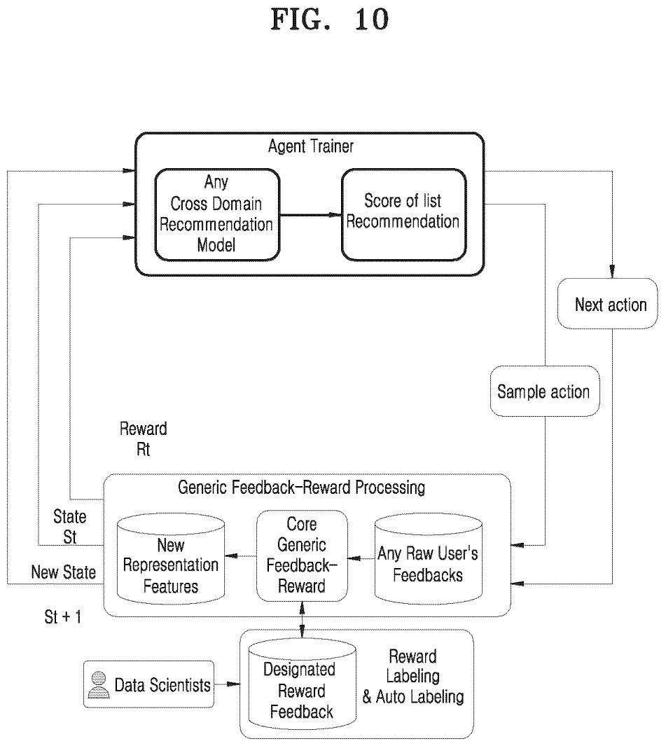

FIG. 10 is an Agent Trainer Part of the overall online adaptive method according to an embodiment of the disclosure.

Referring to FIG. 10, it shows the Agent Trainer Part on the Overall Online adaptive method. When the Agent Trainer gets feedback from the environment or users, this is where the Proximal Policy Optimization (PPO) and REINFORCE take action. RL fluctuates significantly with respect to the reward therefore, it is sometimes unstable. REINFORCE may put certain conditions on whether or not the model should take action. This condition is called Policy. The RL agent must obey the Policy. Unfortunately, it does not resolve the entire problem involved. In REINFORCE, the Policy is based on the previous RL agent before the update. If the model is corrected by a false action or reward, it will return an incorrect action.

PPO solved this issue and nominated it as a breakthrough in the RL algorithm. PPO may limit the Policy by adding trust region by surrogate loss. Surrogate loss may be a term that clipped the reward so it will not fluctuate too high or too low. PPO may have two surrogate losses. Both are denoted as below:

$$ratio = sample action - next action \qquad Equation 3$$

$${surrogate}_{1} = ratio \times global reward$$

$${surrogate}_{2} = clamp ( ratio , 1 - ϵ , 1 + ϵ ) \times reward$$

Where clamp (*) is a function to clip the ratio value, with 1-e being the lower bound and 1+ϵ being the upper bound. The ratio is the difference between the sample action and the next action.

The disclosure may combine REINFORCE with PPO to get a better and more stable RL for the Recommender System. The loss function to update the RL including its agent can be notated as:

$${ℒ}_{total} = {ℒ}_{rec} + max ( {surrogate}_{1} , {surrogate}_{2} ) \qquad Equation 4$$

Where [symbol] _{rec} is the loss from the RL agent and max(*) is the function to get the highest between two values.

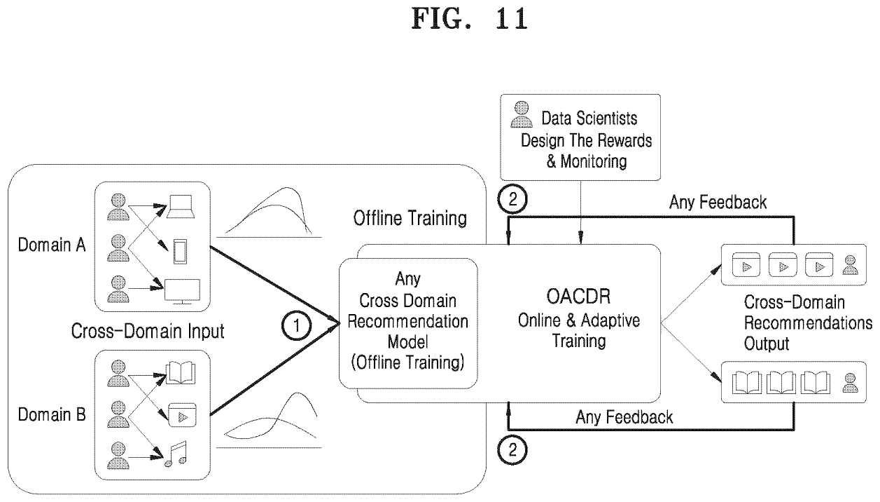

FIG. 11 is a Feedback Processing in an overall Online Adaptive Cross-domain Recommender System according to an embodiment of the disclosure.

Referring to FIG. 11, shows User Feedback Processing in overall OACDR. The User Feedback will serve as an input for the basic cross-domain recommendation model. The system will retrieve User-Item feedback from any domain and form. As the Recommender System relies on user feedback as a labeling mechanism, a common practice among AI models is to utilize both implicit and explicit feedback. Implicit feedback captures user interactions and behaviors that implicitly indicate preferences, such as clicks or viewing history. On the other hand, explicit feedback involves direct input from users, typically in the form of ratings, likes, or similar expressions of preference.

Cross-domain recommendation systems may involve two main components: the source domain and the target domain. The source domain may contain user and item profiles used for modeling, while the target domain may typically only contain item profiles. In some cases, the target domain may also have user profiles, even though these profiles often have limited overlap with users from the source domain. Each domain can have different attributes, for example, activity histories and user transactions. Some attributes may be similar between domains, such as book transactions and movie transactions.

Referring to FIG. 11, there are two types of user feedback data relevant to cross-domain recommendation. First, basic feedback for initial cross-domain model development. Typically, Recommender Systems may require user feedback data for model training, such as implicit or explicit ratings. This feedback may serve as the target variable for almost the entire machine learning algorithms. Second, customized input for online and adaptive models, in which the feedback itself can be anything and accomplishable in parallel. The customized input may be composed of the output of a generic cross-domain recommendation model and the custom feedback from Data Scientists.

Feedback received during the training operation will create internal representations, which will be called offline training. There are two types of representations used in cross-domain recommendations. First is Implicit Representation, a numerical representation of user behavior that is only valuable if the user has an established pattern or historical data such as past activity. This representation is utilized during offline training. Second is Explicit Representation, a representation that incorporates aspects expressly shared by the user directly, such as reviews or ratings. This representation is used in Generic Feedback-Reward Processing.

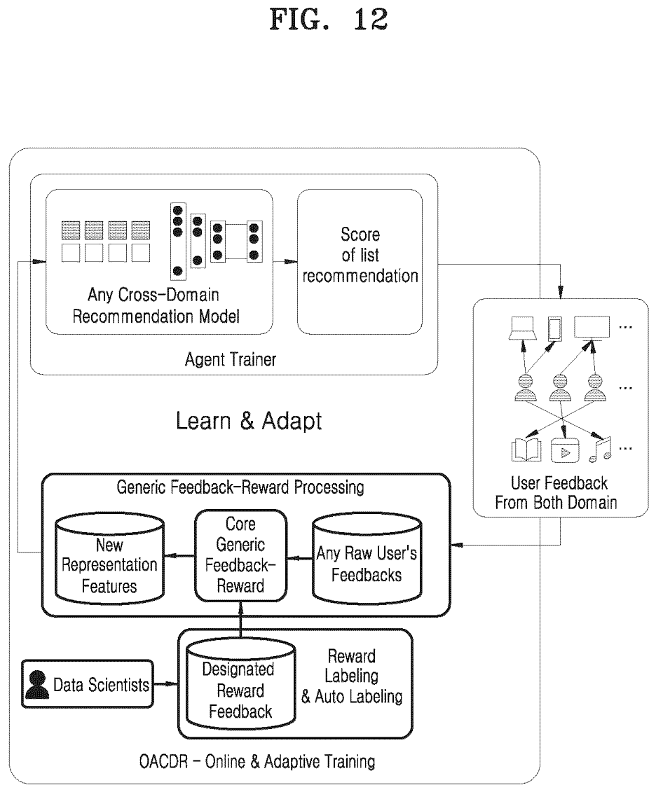

FIG. 12 is an overview of Generic Feedback-Reward Processing in an Overall Online Adaptive Cross-domain Recommender System according to an embodiment of the disclosure.

Referring to FIG. 12 describes the Overview of Generic Feedback-Reward Processing in Overall OACDR. In this part, the system will collect any kind of feedback from users and process it into another representation to be consumed by the Agent Trainer to optimize the model. The Core Generic Feedback-Reward module may process the online user feedback, explicit (e.g. buy, rating, liked, etc.) or implicit (e.g. user behaviors click, view, etc.), and turn it into numerical reward value or explicit representation. The module may use Designated Reward Factor Feedback to adjust all input feedback value to be more relevant to the analysis from the Data Scientists. The output of the module may be a new representation feature that will be used by the Agent Trainer to update the model and generate the updated recommendation to be adapted to the latest user behavior.

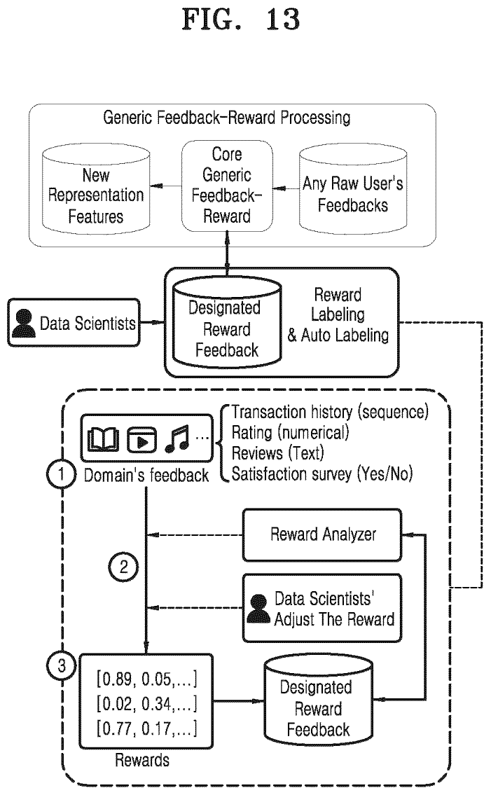

FIG. 13 is a data flow of Reward Labeling & Auto Labeling according to an embodiment of the disclosure.

Referring to FIG. 13, it describes Reward Labelling & Auto Labelling. In this module, Data scientists are responsible for the model life cycle. After the model is trained on the offline training, the fine-tuning will be in the online training operation. During this operation, the inputted reward is created by data scientists. With this degree of freedom, the model can be arranged after the current business process.

In this module, there is “Designated Reward Feedback” which is a database to put all labeled rewards which already been designed by data scientists and will be used to perform the auto-labeling. FIG. 13 shows several operations to produce the reward for the model with a sequence of 3 operations.

Operation 1 is Domain's Feedback, where each collected domain data comes along with the user's feedback. It may come with various feedback types, like Transaction history (sequence), Rating (numerical), User's Reviews/Comments (text), or Satisfaction Survey (Yes/No).

Operation 2 is composed of two options, Reward Analyzer and Data Scientists' Adjusted Reward. Reward Analyzer may be all recorded types of feedback that have already agreed with a certain adjusted reward formula and will be automatically mapped to targeted rewards. This will cost down the time of designing new rewards if the existing formula is proven on a certain domain. Data Scientists' Adjusted Reward may be if the data does not have any similar record, Data Scientists will formulate a systemic reward based on the business values of the domain/service. In this case, Data Scientists may be responsible for transforming the business process into mathematical equations that convert user feedback into rewards.

Operation 3 is Rewards. The rewards will be used by the system to update the model. This process will adjust the feedback into a reward factor. After the process, these values will be stored in the designated reward database.

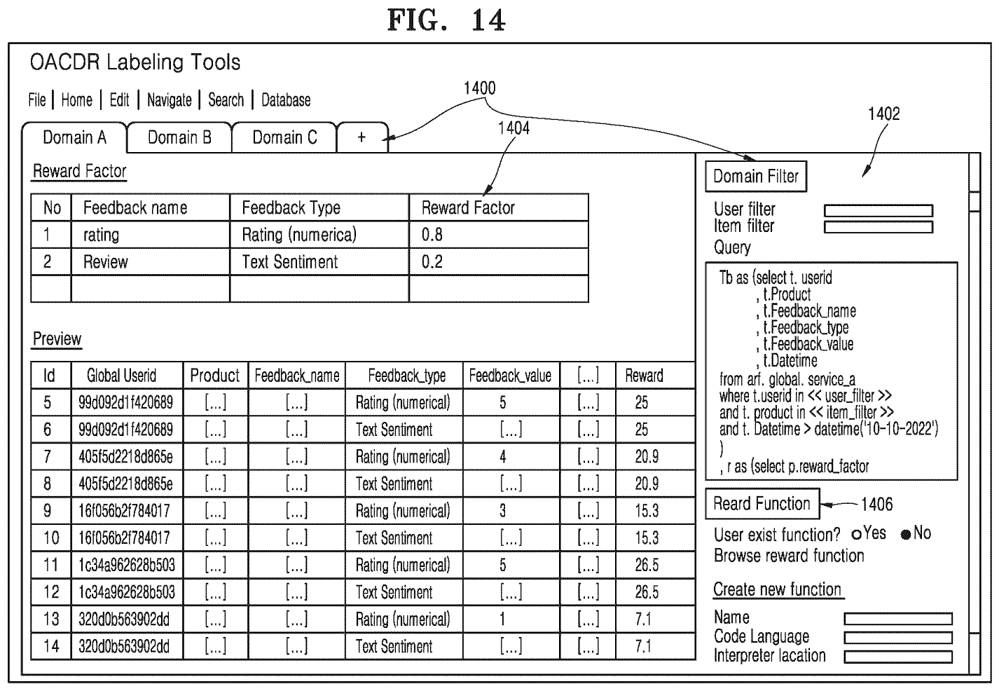

FIG. 14 is an Online Adaptive Cross-domain Recommender System Labelling Tools Wireframe according to an embodiment of the disclosure.

Referring to FIG. 14, it shows the preview wireframe of OACDR labeling tools used by data scientists. This tool is generic enough to manage cross-domain data and label each user's feedback to be a reward factor. Referring to 1400, the data scientists can add many domains, based on different apps, categories, etc., which filtered in domain filter. The domain filter 1402 may filter only selected users, items, or any columns that will be included by the data. Reward factor table 1404 may present a weighting for each reward type. Reward function 1406 that may use a modified formula used by the data scientists. The users can choose using the existing function and mapping automatically or using a new function.

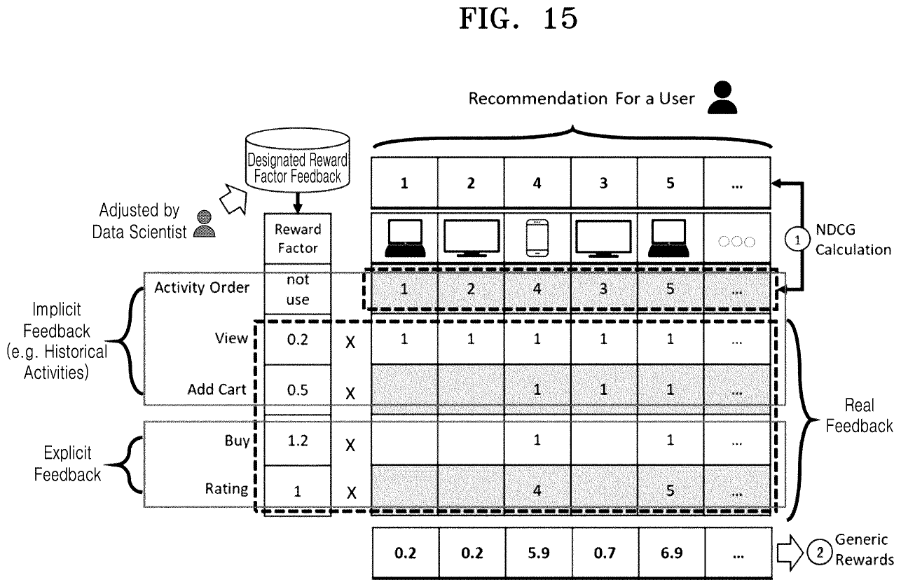

FIG. 15 is the calculation of Generic Feedback-Reward according to an embodiment of the disclosure.

Referring to FIG. 15, shows the mechanism in our system to calculate the feedback from all users. The global reward may be the multiplication of these two kinds of rewards, which are NDCG Rewards and Generic Rewards. First, NDCG Rewards may be calculated based on the order of user pick, by comparing the real activity vs generated recommendation. Second, Generic Rewards, the input of this reward is general enough, it can be any implicit feedback or explicit feedback. Generic Rewards may be calculated by multiplying each feedback with the reward factor and summing all. Both data implicit and explicit will be multiplied by the designed reward factor which is adjusted by the data scientist or admin as explained in the previous module.

This disclosure has four main features.

Firstly, the disclosure is flexible enough to integrate cross-domain recommendations between services or categories of items in the same service.

Secondly, this disclosure can use any deep learning model for cross-domain cases, by combining offline and online training through separate processes.

Thirdly, this disclosure utilizes reinforcement learning in online training to adapt to user behavior and optimize any cross-domain model to maintain its precision during the shifting of trends in the data. Due to the utilization of Reinforcement learning, the data scientists can design its reward function, which in regards reflects its business values and impacts.

Fourthly, the input of the training process in this disclosure is generic enough to employ both implicit and explicit feedback and combine them to global reward for reinforcement learning.

It will be appreciated that an embodiment of the disclosure according to the claims and description in the specification can be realized in the form of hardware, software or a combination of hardware and software.

Any such software may be stored in computer readable storage media (e.g. a non-transitory computer-readable storage media). The computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are an embodiment of machine-readable storage (e.g. a non-transitory machine-readable storage) that are suitable for storing a computer program or computer programs comprising instructions that, when executed, implement an embodiment of the disclosure. Accordingly, an embodiment provide a program comprising code for implementing apparatus or a method as claimed in any one of the claims of this specification and a machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

In an embodiment, the method may include adaptively-training, by the electronic device, a recommendation system. The method, wherein the adaptively-training of the recommendation system may include applying machine learning (e.g., Reinforcement Learning) over a pre-trained model. The method, wherein the adaptively-training of the recommendation system may include combining the machine learning (e.g., Reinforcement Learning) with an application of at least one cross-domain recommendation.

In an embodiment, the method, wherein the machine learning may include a proximal policy optimization (PPO) of reinforcement learning.

In an embodiment, the method, wherein the adaptively-training of the recommendation system may include adapting to a dynamic of user behavior or interest. The method, wherein the adaptively-training of the recommendation system may include integrating cross-domain recommendations between services or categories of items in a same service using a deep learning model. The method, wherein the adaptively-training of the recommendation system may include optimizing a cross-domain model.

In an embodiment, the method, wherein the receiving of the feedback may include receiving at least one of a transaction history, a satisfaction survey, a textual user review, or a numeral rating.

In an embodiment, the method, wherein the providing of the updated recommendation may include processing the received user feedback. The method, wherein the providing of the updated recommendation may include generating an evaluation of the feedback from the user.

In an embodiment, the method may include adaptively-training, by the electronic device, a recommendation system. The method, wherein the adaptively-training of the recommendation system may include applying the received feedback as an input to a training process, wherein the feedback comprises being generic enough and capable to employ both implicit and explicit feedback. The method, wherein the adaptively-training of the recommendation system may include combining a result of the training process with a global reward for machine learning (e.g., Reinforcement Learning).

In an embodiment, the method, wherein the training process may include applying feedback-reward processing with the machine learning (e.g., Reinforcement Learning). The method, wherein the training process may include updating a reward function to reflect a current business environment.

In an embodiment, the method, wherein the reward function may be updated based on at least one of retention, frequency, and monetary.

In an embodiment, the electronic device, wherein the one or more computer programs further include computer-executable instructions that, when executed by the one or more processors, may cause the electronic device to adaptively-train a recommendation system. The electronic device, wherein to adaptively-train the recommendation system, the one or more computer programs further include computer-executable instructions that, when executed by the one or more processors, may cause the electronic device to apply machine learning (e.g., Reinforcement Learning) over a pre-trained model. The one or more processors may cause the electronic device to combine the machine learning (e.g., Reinforcement Learning) with an application of at least one cross-domain recommendation.

In an embodiment, the electronic device, wherein the machine learning may include a proximal policy optimization (PPO) of reinforcement learning.

In an embodiment, the electronic device, wherein, to adaptively-train the recommendation system, the one or more computer programs further include computer-executable instructions that, when executed by the one or more processors, may cause the electronic device to adapt to a dynamic of user behavior or interest. The one or more processors, may cause the electronic device to integrate cross-domain recommendations between services or categories of items in a same service using a deep learning model. The one or more processors, may cause the electronic device to optimize a cross-domain model.

In an embodiment, the electronic device, wherein, to receive the feedback, the one or more computer programs further include computer-executable instructions that, when executed by the one or more processors, may cause the electronic device to receive at least one of a transaction history, a satisfaction survey, a textual user review, or a numeral rating.

In an embodiment, the electronic device, wherein, to provide the updated recommendation, the one or more computer programs further include computer-executable instructions that, when executed by the one or more processors, may cause the electronic device to process the received user feedback. The one or more processors, may cause the electronic device to generate an evaluation of the feedback from the user.

In an embodiment, the electronic device, wherein the one or more computer programs further include computer-executable instructions that, when executed by the one or more processors, may cause the electronic device to adaptively-train a recommendation system. The electronic device, wherein to adaptively-train the recommendation system, the one or more computer programs further include computer-executable instructions that, when executed by the one or more processors, may cause the electronic device to apply the received feedback as an input to a training process, wherein the feedback comprises implicit and explicit feedback. The one or more processors may cause the electronic device to combine a result of the training process with a global reward for machine learning (e.g., Reinforcement Learning).

In an embodiment, the electronic device, wherein, to perform the training process, the one or more computer programs further include computer-executable instructions that, when executed by the one or more processors, may cause the electronic device to apply feedback-reward processing with the machine learning (e.g., Reinforcement Learning). The one or more processors, may cause the electronic device to update a reward function to reflect a current business environment.

In an embodiment, the electronic device, wherein the reward function is updated based on at least one of retention, frequency, and monetary.

In an embodiment, the one or more computer-readable storage media, the operations may include adaptively-training, by the electronic device, a recommendation system. The operations, wherein the adaptively-training of the recommendation system may include applying machine learning (e.g., Reinforcement Learning) over a pre-trained model. The operations, wherein the adaptively-training of the recommendation system may include combining the machine learning (e.g., Reinforcement Learning) with an application of at least one cross-domain recommendation.

In an embodiment, an Online Adaptive Cross-Domain Recommender System, a method to integrate explicit and implicit feedback in a recommendation system with a combined offline and online training approach. The term “online training” within this invention refers to the utilization of Reinforcement Learning (RL) during the training process, thereby enhancing the precision of the pre-trained model. The term “offline training” is employed in this invention to designate the application of any cross-domain recommendation. The term “adaptive” is employed to denote the capability of the trained model to adjust to alteration in concept or user behavior, concurrently enhancing the model's personalization for users. The components involved inside the said system are:

Agent Trainer, a pivotal component responsible for providing sound recommendations based on the user profile aligned with the target domain. It also functions as a Reinforcement Learning (RL) Agent. The component serves as the initial point of the system, where it undergoes retraining to enhance effectiveness during the Online Training evaluation phase.

User Feedback, an integral component of a recommendation system to reflect user behavior and improve suggestions. User Feedback may take various forms, such as textual user reviews or numeral ratings.

Generic Feedback-Reward Processing, a component designed to process user feedback and generate a meaningful evaluation for the Agent Trainer. The component is essential for mirroring business values that correlate with the Recommender System and Data Scientists are actively involved in the development and maintenance of this component.

In an embodiment, the process of component, wherein the system will apply Agent Trainer to adapt to the dynamic of user behavior or interest. The disclosure allowed flexibility to integrate cross-domain recommendations between services or categories of items in the same services. The component also allowed us to use any deep learning model for cross-domain cases by combining offline and online training through separate processes. In an online training manner, the disclosure utilizes reinforcement learning to adapt to user behavior and optimize any cross-domain model to maintain its precision during the shifting of trends in the data.

In an embodiment, the process of component, wherein the system will apply User Feedback resulting in the input of the training process being generic enough and capable to employ both implicit and explicit feedback. The result will be combined with the global reward for Reinforcement Learning.

In an embodiment, the process of component, wherein the system will apply Generic Feedback-Reward Processing with the utilization of Reinforcement Learning. Due to the use of Reinforcement learning and the generic reward mechanism, data scientists can easily design or redesign its reward function to reflect the current business values.

What is claimed is:

1. A method performed by an electronic device, the method comprising:
providing, by the electronic device, a recommendation to a user based on a profile of the user;
receiving, by the electronic device, feedback based on the recommendation; and
providing, by the electronic device, an updated recommendation based on the received feedback,
wherein the feedback is at least one of explicit or implicit.

2. The method of claim 1, further comprising:
training, by the electronic device, a recommendation system,
wherein the training of the recommendation system comprises:
applying machine learning over a pre-trained model; and
combining the machine learning with an application of at least one cross-domain recommendation.

3. The method of claim 2, wherein the machine learning comprises a proximal policy optimization (PPO) of reinforcement learning.

4. The method of claim 2, wherein the training of the recommendation system comprises:
adapting to a dynamic of user behavior or interest;
integrating cross-domain recommendations between services or categories of items in a same service using a deep learning model; and
optimizing a cross-domain model.

5. The method of claim 1, wherein the receiving of the feedback comprises receiving at least one of a transaction history, a satisfaction survey, a textual user review, or a numeral rating.

6. The method of claim 1, wherein the providing of the updated recommendation comprises:
processing the received feedback; and
generating an evaluation of the feedback from the user.

7. The method of claim 1, further comprising:
training, by the electronic device, a recommendation system,
wherein the training of the recommendation system comprises:
applying the received feedback as an input to a training process; and
combining a result of the training process with a global reward for machine learning.

8. The method of claim 7, wherein the training process comprises:
applying feedback-reward processing with the machine learning; and
updating a reward function to reflect a current business environment.

9. The method of claim 8, wherein the reward function is updated based on at least one of retention, frequency, and monetary.

10. An electronic device, comprising:
a display;
memory storing one or more computer programs; and
one or more processors communicatively coupled to the display and the memory,
wherein the one or more computer programs include computer-executable instructions that, when executed by the one or more processors, cause the electronic device to:
provide a recommendation to a user based on a profile of the user,
receive feedback based on the recommendation, and
provide an updated recommendation based on the received feedback, wherein the feedback is at least one of explicit or implicit.

11. The electronic device of claim 10, wherein the one or more computer programs further include computer-executable instructions that, when executed by the one or more processors, cause the electronic device to:
train a recommendation system,
wherein, to train the recommendation system, the one or more computer programs further include computer-executable instructions that, when executed by the one or more processors, cause the electronic device to:
apply machine learning over a pre-trained model, and
combine the machine learning with an application of at least one cross-domain recommendation.

12. The electronic device of claim 11, wherein the machine learning comprises a proximal policy optimization (PPO) of reinforcement learning.

13. The electronic device of claim 11, wherein, to train the recommendation system, the one or more computer programs further include computer-executable instructions that, when executed by the one or more processors, cause the electronic device to:
adapt to a dynamic of user behavior or interest,
integrate cross-domain recommendations between services or categories of items in a same service using a deep learning model, and
optimize a cross-domain model.

14. The electronic device of claim 10, wherein, to receive the feedback, the one or more computer programs further include computer-executable instructions that, when executed by the one or more processors, cause the electronic device to:
receive at least one of a transaction history, a satisfaction survey, a textual user review, or a numeral rating.

15. The electronic device of claim 10, wherein, to provide the updated recommendation, the one or more computer programs further include computer-executable instructions that, when executed by the one or more processors, cause the electronic device to:
process the received feedback, and
generate an evaluation of the feedback from the user.

16. The electronic device of claim 10, wherein the one or more computer programs further include computer-executable instructions that, when executed by the one or more processors, cause the electronic device to:
train a recommendation system,
wherein, to train the recommendation system, the one or more computer programs further include computer-executable instructions that, when executed by the one or more processors, cause the electronic device to:
apply the received feedback as an input to a training process, and
combine a result of the training process with a global reward for machine learning.

17. The electronic device of claim 16, wherein, to perform the training process, the one or more computer programs further include computer-executable instructions that, when executed by the one or more processors, cause the electronic device to:
apply feedback-reward processing with the machine learning, and
update a reward function to reflect a current business environment.

18. The electronic device of claim 17, wherein the reward function is updated based on at least one of retention, frequency, and monetary.

19. One or more non-transitory computer-readable storage media storing one or more computer programs including computer-executable instructions that, when executed by one or more processors of an electronic device, cause the electronic device to perform operations, the operations comprising:
providing, by the electronic device, a recommendation to a user based on a profile of the user;
receiving, by the electronic device, feedback based on the recommendation; and
providing, by the electronic device, an updated recommendation based on the received feedback,
wherein the feedback is at least one of explicit or implicit.

20. The one or more non-transitory computer-readable storage media of claim 19, the operations further comprising:
training, by the electronic device, a recommendation system,
wherein the training of the recommendation system comprises:
applying machine learning over a pre-trained model; and
combining the machine learning with an application of at least one cross-domain recommendation.
